(19) United States
(12) Patent Application Publication
(10) Pub. No.: US 2026/0221919 A1
(43) Pub. Date: Jul. 30, 2026

(54) VECTOR CONTROL METHOD FOR A SYNCHRONOUS MACHINE, AND CONTROL UNIT

(71) Applicant: Schaeffler Technologies AG & Co. KG, Herzogenaurach (DE)

(72) Inventors: Florian Eberhardt, Stuttgart (DE); Florian Von Bertrab, Karlsruhe (DE)

(73) Assignee: Schaeffler Technologies AG & Co. KG, Herzogenaurach (DE)

(21) Appl. No.: 19/148,703

(22) PCT Filed: Jan. 17, 2024
(86) PCT No.: PCT/DE2024/100039

§ 371 Date: Jul. 17, 2025

(30) Foreign Application Priority Data
Jan. 18, 2023 (DE) 10 2023 101 155.3

(51) Int. Cl. H02P 25/03; H02P 21/00; H02P 21/28; H02P 21/36; H02P 29/60

(52) U.S. Cl. CPC H02P 25/03; H02P 21/0025; H02P 21/28; H02P 21/36; H02P 29/60; H02P 2205/05

(57) ABSTRACT

A vector control method for a synchronous machine, in particular a permanent magnet synchronous machine is provided. Q-axis and D-axis target currents are determined by respective allocations which link a target torque and a target flow rate to the Q-axis target current and the D-axis target current, respectively, without taking into consideration a voltage variation of a voltage to be applied to stator windings of the synchronous machine. The voltage variation is adjusted or compensated for beforehand by adapting the target flow rate. A control unit which is designed and programmed to carry out the vector control method is also provided.

### CROSS-REFERENCE TO RELATED APPLICATIONS

This application is the United States National Phase of International Application PCT/DE2024/100039, filed Jan. 17, 2024, which claims priority to German Application 10 2023 101 155.3, filed Jan. 18, 2023. The disclosures of the above applications are incorporated herein by reference.

### TECHNICAL FIELD

The disclosure relates to a vector control method for a synchronous machine, such as a permanent magnet synchronous machine (PMSM). Additionally, the disclosure relates to a control unit designed and programmed to carry out the vector control method.

### BACKGROUND

For effective operation of a synchronous machine, it is important that optimum currents for efficiency are applied to the stator windings of the synchronous machine depending on a present operating point. As the speed of a rotor of the synchronous machine increases, an increasing voltage is required due to the back electromagnetic force (back EMF). In order to be able to operate the synchronous machine, even at high speeds, when a maximum voltage of a power electronics unit that drives the stator windings is reached, the magnetic field of the synchronous machine is weakened by adjusting the currents accordingly. Otherwise, operation of the synchronous machine may become unstable or even uncontrollable. In generator operation of the synchronous machine, if the maximum voltage is exceeded, current peaks that can damage the power electronics unit and oscillating torques that deviate significantly from the required target torque can occur. The oscillating torques lead to unsafe driving behavior in electric vehicles, for example, which must therefore be prevented at all costs. Due to limitations of the hardware of a control unit that controls or regulates the operation of the synchronous machine, control or regulation methods must also be designed to be computationally and memory efficient.

Typically, the optimal-efficiency currents for the operation of the synchronous machine are stored in lookup tables. One table is used for a D-axis current and one table for a Q-axis current, in which the currents are stored as a function of a target torque (positive and negative), a speed, a voltage that can be applied to the stator windings by the power electronics unit, in particular an applicable DC voltage, and a rotor temperature. Alternatively, the currents can also be stored as a function of a target torque, a speed and a rotor temperature. In this case, the speed is scaled according to a ratio of the voltage that can be applied to the stator windings by the power electronics unit to the nominal voltage of the power electronics unit, i.e., a maximum voltage that can be applied by the power electronics unit. For example, with a ratio of 0.5, the speed is doubled.

The input variables target torque and speed are usually written off at a much higher level than the input variables temperature and voltage because they vary significantly more during operation of the synchronous machine and have a greater influence on the currents.

The relationship between current and speed is approximately inversely proportional. This must be taken into account by a highly uneven distribution of the support points and can therefore lead to large interpolation errors.

A plurality of methods for field weakening in order to increase the speed of a rotor beyond a base speed are known. Often, when a specified voltage is exceeded, e.g., the maximum voltage or a specified proportion (e.g., 90%) of the maximum voltage, negative D-axis current is additionally applied in order to weaken the stator field at many operating points. The Q-axis current can then be adjusted to keep the torque constant. For a D-axis current that is smaller than a short-circuit current, additional negative D-axis current no longer reduces the required voltage, but actually even leads to an increase in the voltage at the stator windings. This leads to an inversion of the control path and to unstable operation of the synchronous machine. This field weakening method is therefore not capable of weakening the stator field for synchronous machines that are operated in motor operation with a D-axis current that is smaller than the short-circuit current and also has the disadvantage that the control variable has a strongly non-linear relationship to the actuating variable.

In his dissertation “Effiziente und dynamische Drehmomenteinprägung in hoch ausgenutzten Synchronmaschinen mit eingebetteten Magneten [Efficient and dynamic torque injection in highly utilized synchronous machines with embedded magnets]”, T. Gemaßmer describes a superimposed voltage regulator as an alternative to field weakening, which regulates the speed to be entered into the lookup tables towards higher values or the supply voltage input towards lower values if a voltage to be applied to the stator windings is greater than a specified voltage. However, this method has the disadvantage that it is difficult to correctly limit the use of field weakening towards a low voltage. This is because each torque, depending on the present speed, has a different minimum voltage at which no field weakening is required. In practice, this regulation must therefore be limited in such a way that the field is only weakened. A field weakening stored in the tables, which is, for example, too strong for an optimum generator operation for efficiency of the synchronous machine, cannot be prevented or reversed.

### SUMMARY

The disclosure provides an improved vector control method for a synchronous machine and a control unit.

One aspect of the disclosure provides the vector control method for a synchronous machine, such as a permanent magnet synchronous machine (PMSM). Q-axis and D-axis target currents are determined by respective associations which link a target torque and a target flux to the Q-axis target current and the D-axis target current, respectively, without taking into consideration a voltage variation of a voltage to be applied to stator windings of the synchronous machine. The associations can be stored, for example, as a lookup table. The voltage variation is adjusted or compensated for beforehand by adapting the target flux. The voltage variation is primarily a voltage drop across a resistance in the stator windings. However, the voltage variation is also influenced by losses in a power electronics unit for controlling the synchronous machine and a voltage drop in the lines used. The voltage variation therefore weakens a field in the synchronous machine. The voltage variation can be compensated for in the method without extending the association. The method also takes advantage of the fact that the ideal Q-axis and D-axis currents are approximately linearly related to the flux. It should be noted that the flux is the quotient of the voltage and the electrical frequency. In contrast to conventional lookup tables, this linear relationship allows the number of support points to be significantly reduced. For example, a short-circuit current point can be represented as a point with a flux of 0 Vs.

In some implementations, the respective associations for determining the Q-axis and D-axis target currents may additionally link a property parameter relating to a variability of magnetic and electrical properties of the synchronous machine with the Q-axis target current or the D-axis target current. The property parameter can preferably be a rotor temperature. As a result, the Q-axis and D-axis target currents can be determined more accurately.

In some examples, the voltage variation can be adjusted based on a flux difference between a maximum flux, which corresponds to a maximum voltage that can be applied by a power electronics unit for controlling the synchronous machine, and a present flux, which corresponds to a voltage presently applied to the stator windings. As a result, the voltage variation can be appropriately adjusted. It should be noted that the maximum flux can be determined as the quotient of a maximum voltage that can be applied to the stator windings by the power electronics unit, i.e., the maximum voltage, and the electrical frequency. The present flux can be determined as the quotient of the voltage presently applied to the stator windings and the electrical frequency.

In some examples, the flux difference can be inputted into an I-controller to determine a correction flux. Consequently, the correction flux can be easily determined.

In some examples, a sum of the maximum flux and the correction flux, or an optimal-efficiency flux in the case that the sum exceeds the optimal-efficiency flux, can be used as the target flux. This ensures that the target flux is always limited to the optimal-efficiency flux.

The optimal-efficiency flux may be determined using the maximum torque per ampere (MTPA) method. Consequently, the optimal-efficiency flux may be easily determined.

In some implementations, the target torque can be normalized to a maximum torque, i.e., to the maximum achievable torque at the target flux, and the respective associations for determining the Q-axis and D-axis target currents can receive the normalized target torque as the target torque. In conventional lookup tables, the values of the torques are stored as absolute values. This means that flux values are determined at specified torque intervals, e.g., 10 Nm, and stored in the tables. However, in field weakening operation, the maximum available torque can decrease significantly. As a result, part of the lookup tables is unusable and the resolution in an effectively usable area decreases. In addition, field weakening in the area of a maximum torque of the synchronous machine can lead to severe interpolation errors that are difficult to correct. By normalizing the target torque to the maximum torque and determining the current values at specified intervals of the proportion of the maximum torque, e.g., 0.05 or 0.1, the characteristics of the currents in the range of a maximum torque can be interpolated with sufficient accuracy and a high resolution of the association can be ensured in the entire working range of the synchronous machine.

The maximum torque may be determined on the basis of the target flux and the property parameter. Consequently, the maximum torque may be determined in a simple manner.

In some implementations, the respective associations for determining the Q-axis and D-axis target currents can be parameterized for motor operation of the synchronous machine and generator operation of the synchronous machine can be taken into consideration by inverting the Q-axis target current. As a result, in contrast to parameterization for motor operation and generator operation, the storage space for storing the respective associations can be reduced by half. In contrast to conventional lookup tables, the required storage space can even be reduced to approximately one sixth.

Another aspect of the disclosure provides the control unit designed and programmed to carry out the vector control method. The control unit can receive the required input variables either directly, e.g., from sensors, or indirectly from other control units and carry out any necessary transformations, e.g., Clarke and Park transformations. The control unit can also output parameters for operating a power electronics unit which drives the synchronous machine to the power electronics unit.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 shows a schematic view of an exemplary control unit;

FIG. 2 shows a diagram displaying exemplary current points for current tables for determining a Q-axis target current and a D-axis target current, the diagram showing an MTPA line;

FIG. 3 shows a diagram displaying exemplary current points as a function of a target flux and a target torque as well as an MTPA line;

FIG. 4 shows a diagram displaying exemplary current points determined for values of the target torque normalized to the maximum torque as a function of the target flux and the target torque, as well as an MTPA line;

FIG. 5 shows a schematic view of an exemplary target flux adjustment section of the control unit.

The figures are merely schematic in nature and serve solely for understanding the disclosure. Identical elements are provided with the same reference symbols.

### DETAILED DESCRIPTION

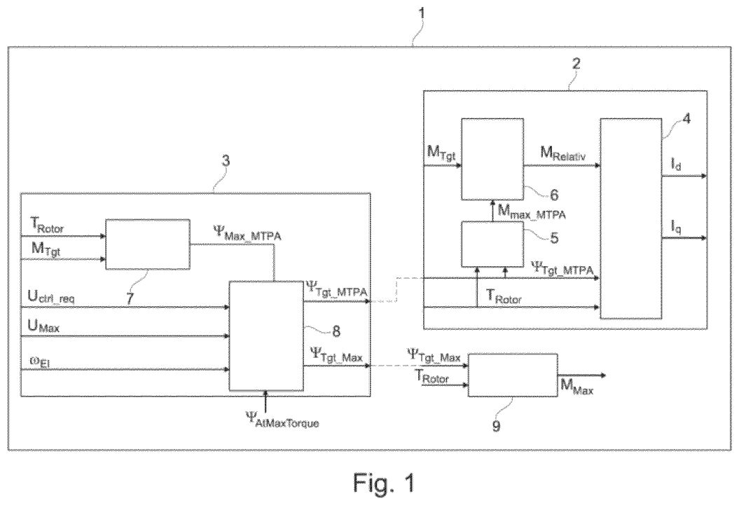

FIG. 1 shows a schematic view of an exemplary control unit 1 for controlling operation of a synchronous machine or a power electronics unit, which in turn controls the synchronous machine. The control unit 1 includes functional sections for carrying out processing operations of an exemplary method. The functional sections are implemented by executing software stored in the control unit 1 or by retrieving data stored in the control unit 1.

As shown in FIG. 1, the control unit 1 has a current determination section 2 and a target flux adjustment section 3. The current determination section 2 in turn has current tables 4 as associations for determining the Q-axis current I_{q} or the D-axis current I_{d}. The current tables 4 have at least a target flux Ψ_{Tgt_MTPA} and a target torque M_{Tgt} as input parameters. This means that the current tables 4 each link the target flux Ψ_{Tgt_MTPA} and the target torque M_{Tgt} with the Q-axis current I_{q} or the D-axis current I_{d}. The links can be stored in a common table or in different tables. If different tables are used, the tables may have different resolutions.

In some examples, the current tables 4 can also have a property parameter relating to a variability of electrical or magnetic properties of the synchronous machine or its components as an input parameter. The current tables 4 have a rotor temperature T_{Rotor} as a further input parameter. Consequently, the currents I_{q} and I_{d} can be determined more precisely.

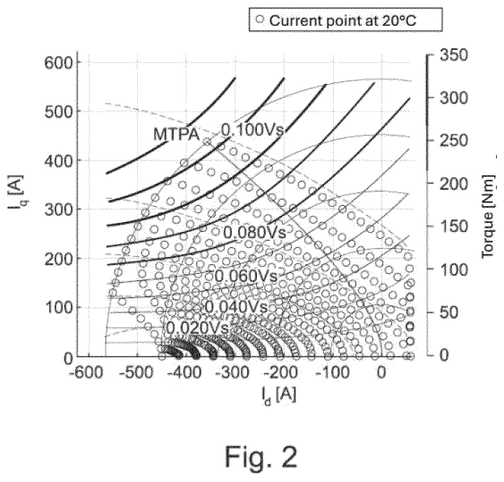

In the current tables 4, only stationary operating points of the synchronous machine are stored, so that terms regarding transient changes in the currents I_{q} and I_{d} are disregarded. Furthermore, current tables 4 only take into account the flux responsible for generating the stator field. A voltage variation influenced by, for example, a voltage drop across stator windings, a loss in the line electronics unit and a voltage drop in the used lines is therefore disregarded in the current tables 4. Due to this approach, current tables 4 cover all voltage levels and speeds. The diagram in FIG. 2 shows current points with the corresponding I_{q} and I_{d} values at a rotor temperature of 20° C. as well as the resulting flux and the achievable torque. The diagram in FIG. 2 therefore illustrates the values stored in the current tables 4.

It should be noted that the flux corresponds to the quotient of the voltage applied to the stator windings and the electrical frequency. The voltage variation thus corresponds to a weakening of the flux due to losses. The electrical frequency can be calculated based on the mechanical speed of a rotor of the synchronous machine and the number of poles.

Furthermore, it was found to be advantageous if, as shown in FIG. 1, the target torque M_{Tgt} is not entered as an absolute value in the current tables 4, but normalized beforehand to a maximum torque M_{max_MTPA}. This is due to the fact that, with increasing speed and consequently with decreasing applicable flux, which results from the maximum voltage that can be applied in field weakening operation, the maximum adjustable torque decreases. Consequently, when using absolute torque values for low fluxes, fewer current points along the torque axis can be used, so only a reduced portion of the current tables 4 can actually be used.

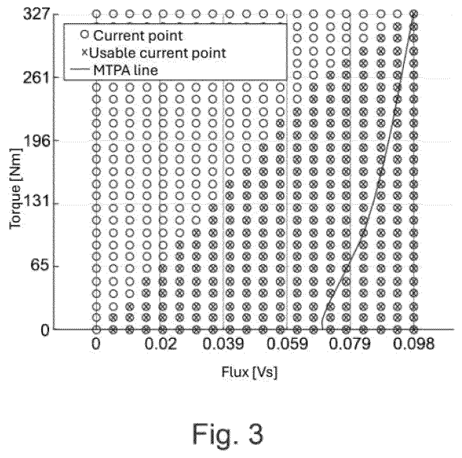

FIG. 3 shows a diagram in which current points for different combinations of target flux Ψ_{Tgt_MTPA} and target torque M_{Tgt} are applied. The individual current points are determined at a given torque interval, e.g., 10 Nm. In addition, a maximum torque per ampere (MTPA) line is drawn in the diagram. Current points that are actually used to control the synchronous machine are marked with an x in the diagram. As described, it can be seen that hardly any current points can be used for low fluxes, since the maximum achievable torque is significantly reduced.

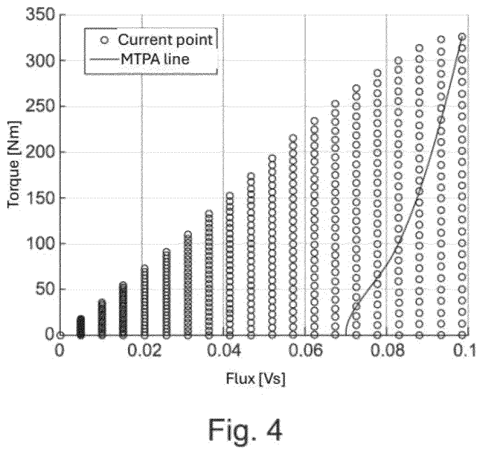

To overcome this drawback, the current determination section 2 may include a maximum torque determination section 5 and a normalization section 6, as shown in FIG. 1. The maximum torque determination section 5 can be designed as a lookup table and can determine a corresponding achievable maximum torque M_{max_MTPA} based on the target flux Ψ_{Tgt_MTPA} and the rotor temperature T_{Rotor}. The maximum torque M_{max_MTPA} corresponds to the highest usable current point in FIG. 3. The target torque M_{Tgt} is then normalized to the determined maximum torque M_{max_MTPA} and entered into current tables 4, which can receive the normalized target torque M_{Relativ} as input parameters. A diagram in FIG. 4 shows current points for different combinations of target flux Ψ_{Tgt_MTPA} and target torque M_{Tgt}, where the current points are determined at specified intervals of the normalized target torque M_{Relative}, e.g., 0.05 or 0.1. It should be noted that the torque axis in the diagram indicates the actual power value. It can therefore be seen in the diagram that, by normalizing the target torque M_{Tgt} to the maximum torque M_{max_MTPA}, a density of current points for low fluxes can be significantly increased, so that a more efficient control of the synchronous machine is possible in this range.

As already mentioned, the current tables 4 disregard a voltage variation of the voltage to be applied to the stator windings. Therefore, an adjustment of the target flux Ψ_{Tgt_MTPA} is necessary in the superimposed or upstream target flux adjustment section 3 to adjust or compensate for the voltage variation.

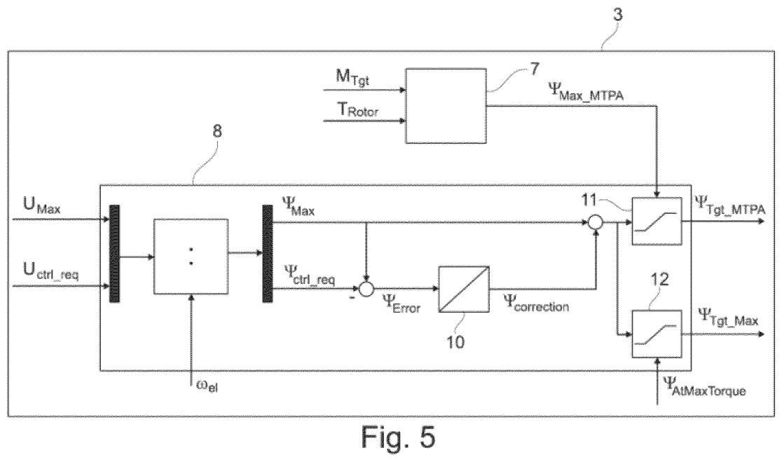

FIG. 5 shows a schematic view of the target flux adjustment section 3, which in turn has a section 7 for determining the optimal-efficiency flux and a voltage regulation section 8. The target flux adjustment section 3 receives the target torque M_{Tgt}, the rotor temperature T_{Rotor}, a maximum voltage U_{Max}, a voltage presently applied to the stator windings U_{ctrl_req} and the present electrical frequency ωₑ₁. It should be noted that the maximum voltage U_{Max} is determined by a limitation of the power electronics unit that controls the synchronous machine.

First, the voltage regulation section 8 calculates from the maximum voltage U_{Max} and the presently applied voltage U_{ctrl_req} the corresponding fluxes, i.e., a maximum flux Ψ_{Max} and a current flux Ψ_{ctrl_req}, by dividing by the electrical frequency ωₑ₁. These values are used to calculate a flux difference Ψ_{Error} as the difference between the maximum flux Ψ_{Max} and the present flux Ψ_{ctrl_req}. The flux difference Ψ_{Error} is then input into an I-controller 10 to obtain a correction flux Ψ_{correction}. This is then added to the maximum flux Ψ_{Max}.

In addition, the section 7 determines an optimal-efficiency flux Ψ_{Max_MTPA} for the target torque M_{Tgt} at the rotor temperature T_{Rotor} using the MTPA method and inputs this into the voltage regulation section 8.

The comparison section 11 of the voltage regulation section 8 then compares the optimal-efficiency flux Ψ_{Max_MTPA} with the sum of maximum flux Ψ_{Max} and correction flux Ψ_{correction} and outputs the minimum of these two values. Consequently, the target flux Ψ_{Tgt_MTPA} is limited to the optimal-efficiency flux Ψ_{Max_MTPA}. This means that a region located to the right of the MTPA line in the diagram in FIG. 4 is disregarded in the control of the synchronous machine. Finally, the adjusted target flux Ψ_{Tgt_MTPA} is output to the current determination section 2, which then determines the Q-axis current I_{q} and the D-axis current I_{d} using the current tables 4.

In addition, the voltage regulation section 8 may have a further comparison section 12 which compares a maximum torque flux Ψ_{AtMaxTorque}, which corresponds to a maximum flux that can be applied at the present operating point, with the sum of the maximum flux Ψ_{Max} and the correction flux Ψ_{correction} and outputs the minimum of these two values as the theoretical maximum target flux Ψ_{Tgt_Max}. Subsequently, as shown in FIG. 1, a section 9 for determining the theoretical maximum torque on the basis of the theoretical maximum target flux Ψ_{Tgt_Max} and the rotor temperature T_{Rotor} outputs a theoretical maximum torque M_{Max}. The theoretical maximum torque M_{Max} is, for example, an important factor with regard to the utilization of the synchronous machine.

In some examples, it is advantageous when the current tables 4 are created only for motor operation of the synchronous machine and stored in the control unit 1. In this case, the generator operation of the synchronous machine is taken into account by inverting the Q-axis current. This is taken into account by inverting the sign of the output Q-axis current in the current determination section 2 when the target torque is negative. This allows the current tables to be smaller, saving storage space in the control unit 1.

A number of implementations have been described. Nevertheless, it will be understood that various modifications may be made without departing from the spirit and scope of the disclosure. Accordingly, other implementations are within the scope of the following claims.

### REFERENCE NUMERALS

1 Control unit
2 Current determination section
3 Target flux adjustment section
4 Current tables
5 Maximum torque determination section
6 Normalization section
7 Section for determining the optimal-efficiency flux
8 Voltage regulation section
9 Section for determining the theoretical maximum torque
10 I-controller
11 Comparison section
12 Comparison section

1. A vector control method for a synchronous machine having stator windings, the method comprising:
determining Q-axis and D-axis target currents by respective associations which link a target torque and a target flux to the Q-axis target current and the D-axis target current, respectively, without taking into consideration a voltage variation of a voltage to be applied to the stator windings of the synchronous machine,
adjusting or compensating for the voltage variation beforehand by adapting the target flux.

2. The vector control method of claim 1, wherein the respective associations for determining the Q-axis target current and the D-axis target current link a property parameter, which relates to a variability of magnetic and electrical properties of the synchronous machine with the Q-axis target current or the D-axis target current.

3. The vector control method of claim 1, further comprising adjusting or compensating for the voltage variation by way of a flux difference between a maximum flux and a present flux.

4. The vector control method of claim 3, further comprising:
inputting the flux difference into an I-controller; and
determining a correction flux based on the flux difference.

5. The vector control method of claim 4, wherein a sum of the maximum flux and the correction flux, or an optimal-efficiency flux when the sum exceeds the optimal-efficiency flux are used as the target flux.

6. The vector control method of claim 5, wherein the optimal-efficiency flux is determined using a maximum torque per ampere (MTPA) method.

7. The vector control method of claim 2, further comprising:
normalizing the target torque to a maximum torque; and
receiving the normalized target torque as the target torque by the respective associations for determining the Q-axis target current and the D-axis target current receive.

8. The vector control method of claim 7, wherein the maximum torque is determined based on the target flux and the property parameter.

9. The vector control method of claim 1, wherein the respective associations for determining the Q-axis and D-axis target currents are parameterized for motor operation of the synchronous machine, and generator operation of the synchronous machine is taken into account by inverting the determined Q-axis current.

10. A control unit designed and programmed to carry out the vector control method of claim 1.

11. The vector control method of claim 1, wherein the synchronous machine is a permanent magnet synchronous machine.

12. The vector control method of claim 1, wherein the magnetic and electrical properties of the synchronous machine include a rotor temperature.
